(19) United States
(12) Patent Application Publication
(10) Pub. No.: US 2021/0276211 A1
(43) Pub. Date: Sep. 9, 2021

(54) RAZOR BLADE WITH IMPROVED ASYMMETRIC PROFILE

(71) Applicant: John Robert Harris, Rancho Palos Verdes, CA (US)

(72) Inventor: John Robert Harris, Rancho Palos Verdes, CA (US)

(21) Appl. No.: 17/191,570

(22) Filed: Mar. 3, 2021

Related U.S. Application Data
(60) Provisional application No. 62/985,693, filed on Mar. 5, 2020.

(51) Int. Cl. B26B 21/56

(52) U.S. Cl. CPC B26B 21/56

(57) ABSTRACT

A new blade for a shaver is disclosed with a profile where a single sided of the blade, rather than a dual sided blade, is ground to make a cutting surface. Such a single sided blade, or “chisel blade” has been found to have important advantages in scrubbing razors in particular, but in general for replaceable razor cartridges, whether used in scrubbing razor configuration or single cartridge applications.

### CROSS-REFERENCES TO RELATED APPLICATIONS

This application claims priority from U.S. Provisional Patent Application No. 62/985,693, filed Mar. 5, 2020, the content of which is incorporated by reference herein in its entirety.

### BACKGROUND

The present invention relates to razor blades of the type used in disposable razors and cartridges, and more particularly relates to an improved blade design which is of particular advantage for scrubbing or two-way razors that impart a self-sharpening capability embodied in the present invention. More specifically, the present invention results in razor blades that are designed to “strop” surfaces of the trailing blades that are positioned at an angle from the cutting blades on the advancing portion of the razor. The present invention further improves the efficiency, quality of shave, and life expectancy of razors incorporating blades of the invention.

Traditional razor blades start out as cut blanks from aluminum or steel alloys, and then the edges are simply ground on both sides to yield a symmetric angled sharp edge. FIGS. 1A,B and 2A,B illustrate profiles of a razor blade tips and their interaction with a skin surface among blades currently in the prior art. Such blade are characterized by profiles that are symmetric about a centerline as the body of the blade transitions to the blade distal edge. The distal edge or tip of the blade for these symmetric examples always lie on the centerline and these blades are the most common of all types of razor blades. To achieve the geometry of the blades shown in FIGS. 1 and 2, both sides of the blade must be grinded so that in the first example a simple “V” shape is formed, and in the second example a multi-faceted, symmetric profile is formed. When there are three separate facets, the blade configuration is referred to as a convex edge. A convex edge may have a smooth transition between each plane and is commonly referred to as a Gothic Arch grind (FIG. 2).

Razor manufacturers select a particular two sided grind profile to meet their specific needs, from single facet to Gothic Arch. For example, single facets are favored by disposable, limited use shavers because they are very sharp but that initial sharpness dulls very rapidly, thus limiting the number of effective shaves with such blades. The manufacturer of such products count on the blades dulling quickly so that the customer will soon repurchase the same type of sharp, disposable shaver. Additional facets may serve to improve blade life but reduce the sharpness of the blade edge when compared with single facet blades. The remaining challenge has been to find the appropriate balance between sharpness and longevity. The present invention advances the longevity of blades while providing an initial sharpness not found on blades having this level of sharpness.

### SUMMARY OF THE INVENTION

The present invention, briefly and in general terms, is for an shaver with blades having a distinct, asymmetric profile obtained by a single grind, rather than a dual sided symmetric blade as is according to the prior art used in razor cartridges. Such a blade ground to form an edge on a single sided blade, referred to herein as a “chisel blade,” has been found to exhibit unexpectedly improved performance and life expectancy advantages over prior art blades in both traditional razors and provide additional benefits in scrubbing razors in particular.

These and other features and benefits of the invention will be best understood by reference to the detailed description below in conjunction with the accompanied drawings.

### BRIEF DESCRIPTION OF THE DRAWINGS

FIG. 1A is a cross-section of a prior art razor blade of the type used in disposable blade cartridges;

FIG. 1B is a cross-section of the prior art razor blade of FIG. 1A as it is used in proximity of the skin of a user;

FIG. 2A is another prior art razor blade with multiple angles on the sides of the blade;

FIG. 2B is a cross-section of the prior art razor blade of FIG. 2A as it is used in proximity of the skin of a user;

FIG. 3A is a first embodiment of a blade of the invention in which only one side of the blade is sharpened at an angle;

FIG. 3B is the blade of FIG. 3A shown in proximity to the skin;

FIG. 4A is a cross-section view of a second embodiment of the invention defining multiple facet angles of the blade on one side opposite the flat blade side;

FIG. 4B is a cross-section of the blade of FIG. 4A as used in proximity of the user's skin;

FIG. 5 is a cross section of blades of FIG. 3A arranged in a multiple blade conventional (single direction) cartridge;

FIG. 6 is a cross-section of blades of FIG. 4A arranged in a multiple blade conventional (single direction) cartridge;

FIG. 7 is a cross section of blades of FIG. 3A arranged in a multiple blade dual direction cartridge; and

FIG. 8 is a cross-section of blades of FIG. 4A arranged in a multiple blade dual direction cartridge.

### DETAILED DESCRIPTION OF THE PREFERRED EMBODIMENTS

FIG. 3 shows a new blade having a one sided gride profile compared to those of the prior art where, instead of a two sided grind, a single “chisel” grind is employed wherein only one side of the blade is sharpened to yield a planar first surface and an angled second surface that meet at the distal edge or tip. This configuration is achieved by grinding only one side of the blade until the tip is formed. Like the symmetric or two sided grinds, the chisel grind can have one (FIG. 3) or multiple (FIG. 4) facets on a first side, but is planar on the entirety of the second side. As with the two sided grinds, the multiple facets of the chisel grind can have smooth transitions to produce a half Gothic Arch configuration, or the transitions can be more pronounced and angular.

No known current blade manufacture uses this proposed chisel grind, which has multiple advantages as explained below. The chisel grind configuration can be used on both single stroke (conventional) shavers and dual or bi-directional shavers such as those described in US Patent Publication No. 2019/0270211 by the present inventor.

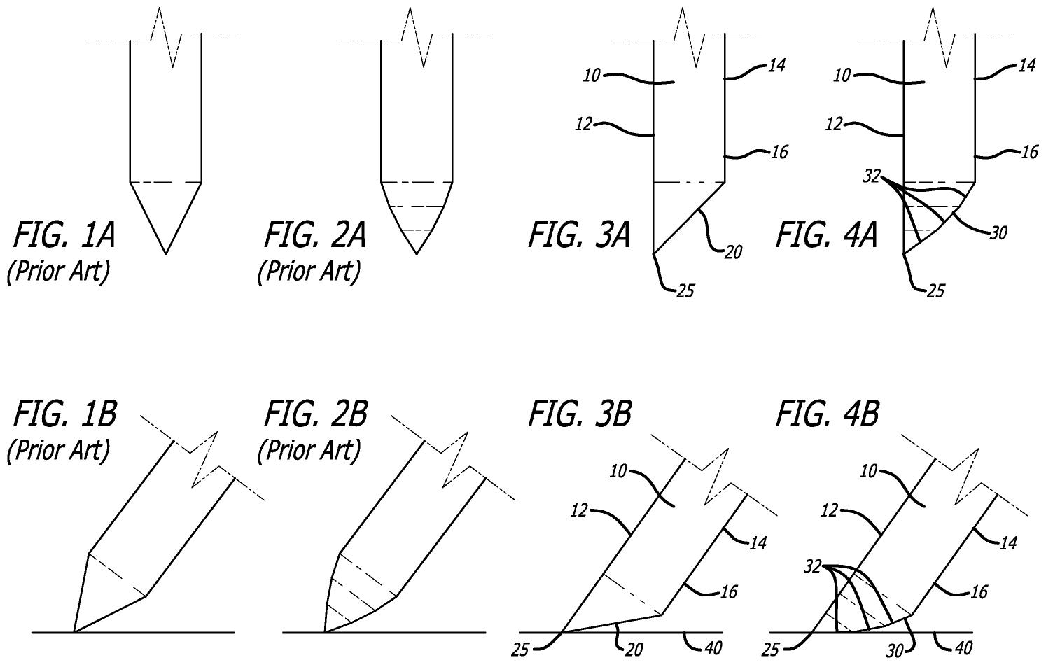

One advantage of the chisel grind as shown in FIGS. 3 and 4 is that it is significantly sharper than the comparable two sided grinds of FIGS. 1 and 2, and can be up to fifty percent sharper while reducing manufacturing steps. This sharper edge leads to a smoother, more comfortable shave for the user. Furthermore, when used on a bi-directional shaver such as that described in U.S. Patent Publication No 2019/0270211, the content of which is fully incorporated herein by reference, the chisel grind produces a unique and superior result. Namely, the chisel grind when used in a bi-directional shaver applies the opposite blade surface to the skin in the reciprocating stroke, stropping a much larger percentage of the blade surface area each time the shaver is reciprocated (compare FIGS. 1B and 3B, 2B and 4B). The proximity of the adjacent blade surface to the skin in reality cases contact with the skin in the retracting direction, leading to more advanced and more pronounced stropping of the blade. This constant polishing or stropping of the blade against the skin has several important effects, such as maintaining a sharpened edge for cutting and also preserving a clean and unclogged blade cartridge. This in turn leads to a longer blade life, a smoother cutting surface, and prolonged sharpness of the cutting edge of the blade.

Bi-directional shavers are used by dragging the blade set in forward and backward (or up and down) directions repeatedly, such that one set of blades cuts in one direction and a second set of blades cut in a second direction. This decreases the time needed to conduct the shaving operation since an area is subjected to twice the number of strokes compared with traditional shavers. As seen in FIGS. 3B and 4B, the chiseled surface 20, 30 of the blade profile of the present invention bears against the skin 40 to a much higher degree as compared with the profiles of FIGS. 1 and 2 (keeping in mind that the skin surface is shown as a sharp straight line, but the skin is more pliant and resilient and bears against the blade surface), leading to a higher degree of polishing or stropping, with as much as one hundred percent of the edge surface bearing against the skin during the stropping down stroke.

As can be seen from the foregoing, the single sided grind, or chisel grind, can improve both traditional and bi-directional razors by improving sharpness and longevity. Further, when used with a bi-directional shaver the chisel grind enhances the stropping function of the up/down (or back/forth) motion of the razor to clean and sharpen blade life of these shavers to an even higher degree.

When combined with a shaver, the invention is characterized by a razor blade 10 (FIG. 3), singularly or in a parallel stack, where the blade 10 has a profile has first surface 12 that is planar along an entirety of the surface, and a second side 14 having a first portion 16 that is planar and parallel to the first surface 12, and a ground second portion 20 that reduces a thickness of the profile in the distal direction until it reaches the first side 12 to form a cutting edge 25 in the distal portion of said blade 10. The invention can further be characterized in a second embodiment where the reduction in thickness of the profile is linear along the ground second portion 20, and a third embodiment where the reduction is a non-linear reduction 30 (FIG. 4). In the non-linear case, the reduction can occur over multiple linear sections 32, where the transitions are smooth and also where the transitions form abrupt changes in the angles of the facets.

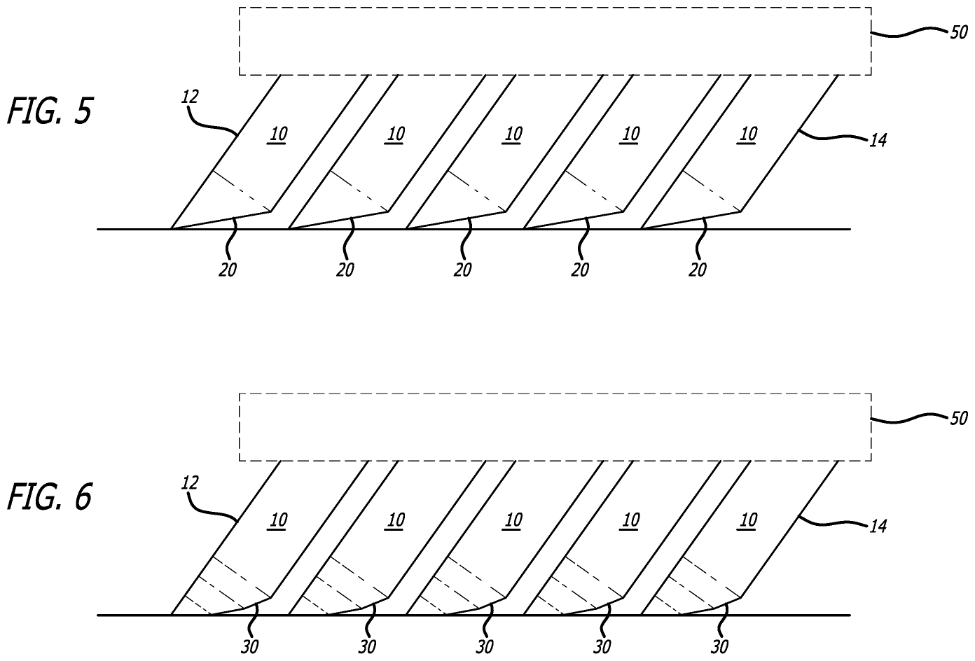

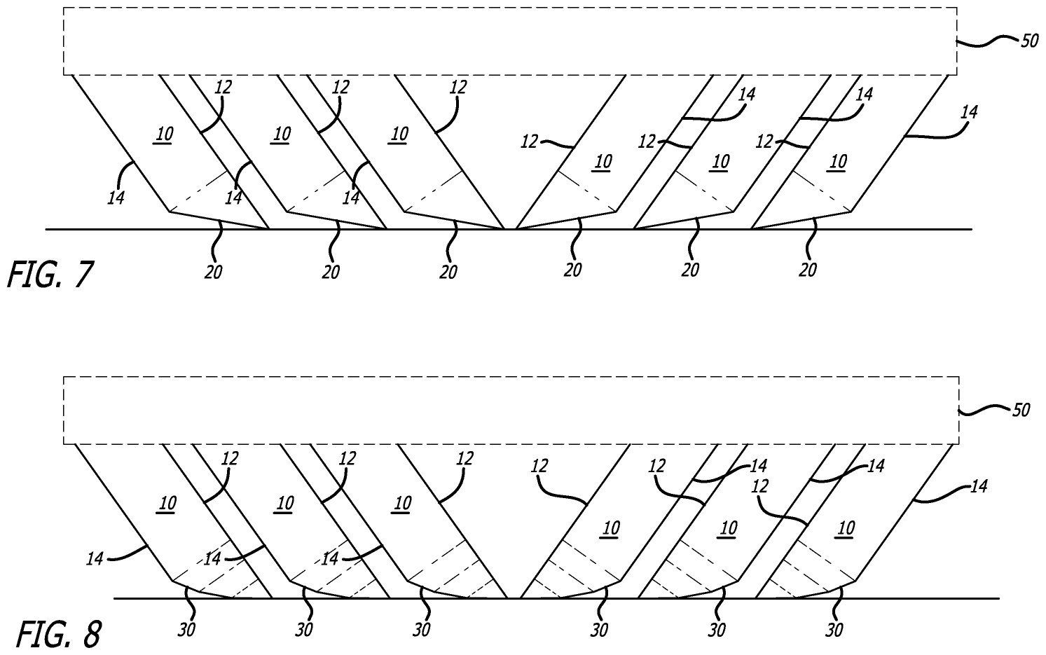

As shown in FIG. 5, the blades may be arranged in a cartridge 50 and the cartridge replaced when the blades become dull. The cartridge 50 may be part of a single direction shaver with a handle and cartridge (see FIGS. 5 and 6), or a bi-directional cartridge using a handle or a cage-like structure (FIGS. 7 and 8).

While the invention is described and depicted using the inventor's best mode, the scope of the invention is not limited to the described embodiments or the depicted embodiments. Rather, a person of ordinary skill in the art will readily recognize the many modifications and substitutions are available to the described embodiments, and the scope is properly determined to include all such embodiments and substitutions. Thus, absent an expressed statement of limitation of the scope, the present invention is properly measured by the appended claims using the ordinary meaning of the words, consistent with but not limited by the present disclosure.

I claim:

1. An improved shaver having a handle and a cartridge carrying a plurality of blades, comprising:
a razor blade having a profile including a first surface that is planar along an entirety of the surface, and a second side having a first portion that is planar and parallel to the first surface, and a ground second portion that reduces a thickness of the profile in the distal direction until it reaches the first side to form a cutting edge at the distal edge of said blade.

2. The improved shaver of claim 1, wherein the reduction in thickness of the blade profile is linear along the ground second portion.

3. The improved shaver of claim 1, wherein the reduction in thickness of the blade is non-linear.

4. The improved shaver of claim 3, wherein the reduction in thickness of the blade occurs over multiple linear sections.

5. The improved shaver of claim 4, wherein transitions between the linear sections of the blade are smoothed.

6. The improved shaver of claim 4, wherein transitions between the linear sections of the blade form apices.

7. The improved shaver of claim 1, wherein the shaver includes a first cartridge that shave in a first direction, and a second cartridge that shaves in a second direction.

8. An improved razor blade, comprising:
a razor body having a profile including a first surface that is planar along an entirety of the surface, and a second side having a first portion that is planar and parallel to the first surface, and a ground second portion that reduces a thickness of the profile in the distal direction until it reaches the first side to form a cutting edge in the distal edge of said blade.

9. The improved razor blade of claim 8, wherein the reduction in thickness of the profile is linear along the ground second portion.

10. The improved razor blade of claim 8, wherein the reduction in thickness is non-linear.

11. The improved razor blade of claim 10, wherein the reduction in thickness occurs over multiple linear sections.

12. The improved razor blade of claim 11, wherein transitions between the linear sections are smoothed.

13. The improved razor blade of 11, wherein transitions between the linear sections form apices.
